(19) United States
(12) Patent Application Publication
(10) Pub. No.: US 2007/0012643 A1
(43) Pub. Date: Jan. 18, 2007

(54) BABY FEEDING SYSTEM

(76) Inventor: Robin R. McKiddy, Cumming, GA (US)

Correspondence Address: GEORGE R. REARDON, 3356 STATION COURT, LAWRENCVILLE, GA, 30044, US

(21) Appl. No.: 11/456,177

(22) Filed: Jul. 7, 2006

Related U.S. Application Data
(60) Provisional application No. 60/700,217, filed on Jul. 18, 2005.

(51) Int. Cl. B65D 1/04; A61J 11/00; A61J 9/00

(52) U.S. Cl. 215/11.1; 215/6

(57) ABSTRACT

A baby feeding system of the bottle, nipple, and protective-cap type is disclosed. This system provides a cap for extending the length of a baby bottle and enabling the person feeding the baby to use his/her chin to continue to hold the baby bottle in the baby's mouth when it is desired to use the bottle-holding hand for another activity for a short duration. Additionally, the cap provides for preventing the leakage of liquid from the baby bottle nipple orifice.

### FIELD OF THE INVENTION

This application claims the benefit of U.S. Provisional Patent Application No. 60/700,217, filed Jul. 18, 2005.

The present invention relates to the field of infant or baby feeding systems of the bottle, nipple, and protective-cap type.

### BACKGROUND OF THE INVENTION

Baby feeding systems of the general type described herein are known. The protective cap is usually retained on the nipple end of the bottle by friction, however other retaining means exist employing one or more raised lips, complimentary screw-like threads or the like are also known.

When feeding a baby, it is important to keep the feeding equipment clean. A bottle whose cap has fallen off or has become lost can expose the nipple to germs and dirt. Also, when the bottle nipple leaks milk or formula due to a lost cap or a cap that has fallen off, the result is a smelly mess due to the wasted formula. Additionally, there are times when the person feeding the baby needs to temporarily free up the hand holding the bottle without interrupting feeding, e.g. to answer a telephone, open a door, or turn a page. Conventional bottles are too short, plus the bottle bottom is not ergonomically formed for the person feeding the baby to utilize his/her chin to hold the bottle during these types of situations.

There are a myriad of patents that have addressed hands-free bottle feeding of a baby. These solutions generally utilize devices that that are designed to independently hold the bottle. There are also patents that address lost or fallen off caps to baby bottles.

Related art that addresses the above problems includes the following patents.

U.S. Pat. No. 4,603,784, issued to Wei C. Chang on Aug. 5, 1996, discloses a nursing bottle system which includes axially joined first and second container bodies or portions. The container bodies are liquid tightly separated from one another by a wall extending perpendicularly to the container axis. Different liquid foods can be carried in the container bodies, and fed as desired to an infant through a nipple provided at the open end of the selected container body of the system.

U.S. Pat. No. 5,183,229, issued to Michael D. Dugan on Feb. 2, 1993, discloses a holder for a baby bottle of the type having a body, a cap and a nipple. The holder consists of a mechanism for retaining the body of the baby bottle. The baby bottle will remain stationary, when the retaining mechanism with the baby bottle is placed onto a mattress in a crib or the like near a mouth of a baby, allowing the baby to always have access to the nipple for feeding.

U.S. Pat. No. 5,211,299, issued to Keith J. Manfredonia on May 18, 1993, discloses a baby bottle formed with a truncated conical cap. The truncated conical cap includes an annular ring adjacent a top wall of the cap, and wherein the bottle portion of the organization includes a truncated conical cavity directed coaxially into the bottle from the bottom wall formed with a plurality of projections for receiving the groove therewithin for storage of the cap structure during periods of non-use.

U.S. Pat. No. 5,269,426, issued to Emanuel P. Morano on Dec. 14, 1993, discloses a baby bottle feeding assembly which includes a hood type enclosure for the nipple, when the bottle is not in use. During periods of bottle use, the hood is stored over the opposite end of the bottle. In order to positively retain the hood in either its nipple protecting or storage condition, the hood includes raised beads, which cooperatively engage complementary protrusions at either end of the bottle so as to provide a positive locking engagement. This engagement may be manually defeatable when it is desired to move the hood to its other desired position on the bottle. When the hood is locked in the storage condition, it is substantially co-extensive with the bottom region of the bottle, so as not to significantly extend beyond the bottle proper.

U.S. Pat. No. 5,316,160, issued to Victor J. J. Cautereels on May 31, 1994, discloses an assembly for mounting a nipple to a baby bottle including an adapter supporting the nipple against free movement through the bottle mouth, and a mounting collar with threaded fasteners engaging complementary fasteners on the bottle and clamping the nipple and adapter to the bottle. The position of the threads allows free rotating of the collar relative to the bottle threads in the absence of the adapter.

U.S. Pat. No. D353,204, issued to Patricia Neff, et al., on Dec. 6, 1994, illustrates a combined bottle and cap.

U.S. Pat. No. D366,936, issued to Brian Q. Young on Feb. 6, 1996, illustrates a baby bottle with a cap.

U.S. Pat. No. D385,041, issued to Robert M. Sanfilippo on Oct. 14, 1997, illustrates a combined baby bottle and cap.

U.S. Pat. No. 5,704,505, issued to Hemchandre Singh on Jan. 6, 1998, discloses an infant bottle feeding system having a supported bottle holder for holding a feeding bottle. The bottle holder has a flat, elongated supporting base which can be placed underneath a supine infant for additional support. A flexible arm is retained by the supported base in an offset manner, thus allowing an infant roll to one side free of the base such that the infant is not trapped beneath the system. The flexible arm supports a bottle retaining clamp which holds a fluid storage vessel of the type conventionally used as infant feeding bottles. A flow restriction means is retained within a cap and away from the nipple, and both are then sealed to the opening of the storage vessel by the cap.

U.S. Pat. No. 5,878,898, issued to Joanne Shefflin on Mar. 9, 1999, discloses an overcap assembly for a fluid container, such as a baby bottle, that protects the nipple, or other fluid dispenser, from contamination and from leaking when the overcap is in the protective, covering position. The overcap has an opening in its top through which the nipple extends once a lid has been removed and the overcap has been shifted from a stable protective position surrounding the nipple to a stable enabling position exposing the nipple for use without removing the overcap from the collar. The lid is preferably tethered, hinged or otherwise connected to the overcap.

U.S. Pat. No. D410,548, issued to Richard S. Chomik on Jun. 1, 1999, illustrates a bottle with a removable bottom cap.

U.S. Pat. No. D417,505, issued to Daniel P. Nuzzo on Dec. 7, 1999, illustrates a combined baby bottle and cap.

U.S. Pat. No. D428,496, issued to Paul Thom et al. on Jul. 18, 2000, illustrates a combined baby bottle and cap.

U.S. Pat. No. 6,123,210, issued to Jae-Hoon Kim on Sep. 26, 2000, discloses a nursing bottle which contains a cap which is also designed and positioned to further have a propping function whereby an infant can suck on a nipple by merely grasping the nursing bottle, but without lifting it. By providing a secondary location for fixing the cap to the bottle, the possible loss of the cap can be avoided.

U.S. Pat. No. 6,302,286 B1, issued to Ingrid Witherspoon on Oct. 16, 2001, discloses an improved baby bottle nipple cover with a cap retainer that keeps the cap in proximity to the opening when not covering the nipple and that leaves the collar free to sealingly secure the nipple. The nipple cover is easily transferable from one baby bottle to another.

U.S. Pat. No. D450,387 S, issued to Ramona m. Gaona on Nov. 13, 2001, illustrates a baby bottle with storage in a cap.

U.S. Pat. No. D463,568 S, issued to Barkie S. W. Leung on Sep. 24, 2002, illustrates a cap and stopper for a baby drinking bottle.

U.S. Pat. No. 6,786,344 B2, issued to Stuart R. Kipperman on Sep. 7, 2004 discloses a baby bottle including an upper and lower circular shaped cylindrical body portion having a first radius, a elliptical shaped cylindrical body portion intermediate the cylindrical upper and lower body portions, where the center portion has a minor axis radius and a major axis radius that are each smaller than the first radius, and a cylindrical top portion located proximate the upper body portion and adapted to receive a removable closure.

U.S. Pat. No. D499,808 S, issued to Christopher Mallet on Dec. 14, 2004, illustrates a feeding bottle.

While these patents and other previous methods have attempted to solve the problems that they addressed, none have utilized or disclosed a baby feeding system with a baby bottle cap which can serve both to retard or stop leakage from a nipple and also to provide a chin support for hands-free feeding of the baby, as does embodiments of the present invention.

Therefore, a need exists for a baby feeding system with these attributes and functionalities. The baby feeding system according to embodiments of the invention substantially departs from the conventional concepts and designs of the prior art. It can be appreciated that there exists a continuing need for a new and improved baby feeding system which can be used commercially. In this regard, the present invention substantially fulfills these objectives.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a baby feeding system having a multi-use baby bottle cap. In particular, the present invention relates to a system employing a baby bottle cap that allows the user to extend the length of the bottle, to feed a baby by using the chin of the user, and to retard or stop a baby bottle nipple from leaking.

The baby bottle cap is formed to fit snugly on either the top or the bottom of a corresponding shaped baby bottle. The means for fitting snugly may be accomplished by the curvature of the bottom of the baby bottle cap, or by corresponding protrusions on the baby bottle top and/or bottom.

The top of the baby bottle cap is formed with an indention in order to serve as a chin rest. Protrusions, e.g. chin grippers, on the top surface of the indention cushion the chin and provide frictional support for the chin. These chin grippers may be affixed to the chin rest or the chin rest may be formed to include the chin grippers.

On the top inside of the baby bottle cap is a protrusion, e.g. a nipple stopper, that is positioned for engaging the top of the baby bottle nipple in order to prevent the passage of liquid through the nipple orifice. The nipple stopper may be formed as part of the baby bottle cap or may be formed separately and affixed to the top inside of the baby bottle cap. The nipple stopper is preferably spherical in shape and may be made of sponge-like material. In other embodiments the nipple stopper may be in other shapes, made from other materials or formed to have a part that fits snugly inside the orifice of the baby bottle nipple.

One aspect of the present invention is that it allows the user to add an extension to a baby bottle.

Another aspect of the present invention is that it gives a user the ability to use his/her chin to hold the bottle during the feeding process.

Another aspect of the present invention is that it addresses the problem of the feeding nipple being exposed to germs due to a lost bottle cap.

Another aspect of the present invention is that it addresses the problem of a bottle leaking in the bottom of a diaper bag.

Another aspect of the present invention is that it can be made inexpensively.

Another aspect of the present invention is that it can be made of readily available materials.

Another aspect of the present invention is that it is easy to use.

These and other features and advantages of the present invention will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates a cutaway view of a baby bottle cap positioned on the top of a corresponding baby bottle, according to an embodiment of the present invention.

FIG. 2 illustrates a front plan view of a baby bottle cap positioned on the top of a corresponding baby bottle, according to an embodiment of the present invention.

FIG. 3 illustrates a front plan view of a baby bottle cap positioned on the bottom of a corresponding baby bottle, according to one embodiment of the present invention.

FIG. 4 illustrates a front plan view of a baby bottle cap, according to an embodiment of the present invention.

FIG. 5 illustrates a perspective view of a baby bottle cap, according to an embodiment of the present invention.

FIG. 6 illustrates a bottom plan view of a baby bottle cap, according to an embodiment of the present invention.

FIG. 7 illustrates a perspective view of a baby bottle cap on the bottom of a corresponding baby bottle, according to an embodiment of the present invention.

FIG. 8 illustrates a perspective view of a baby bottle cap separated from the bottom of a corresponding baby bottle, according to an embodiment of the present invention.

FIG. 9 illustrates a front plan view of a baby bottle cap on the bottom of a corresponding baby bottle, according to an embodiment of the present invention.

FIG. 10 illustrates a perspective view of a baby bottle cap on the top of a corresponding baby bottle, according to an embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

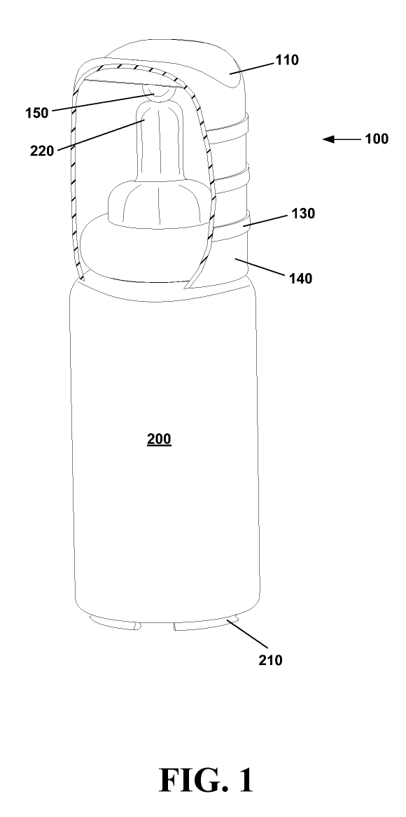

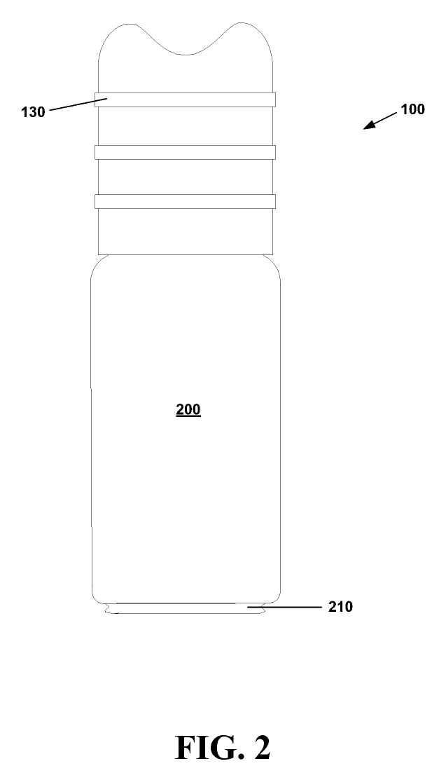

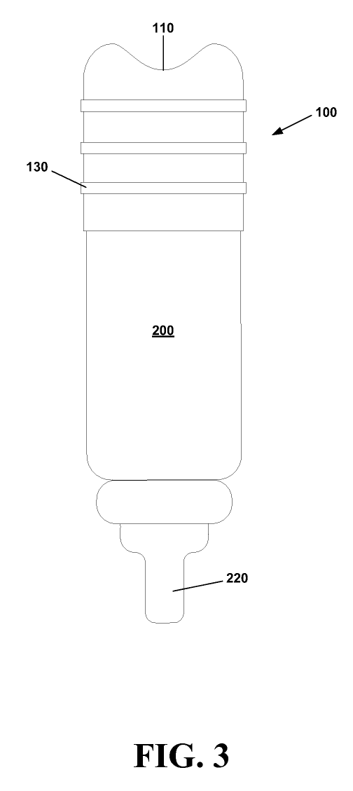

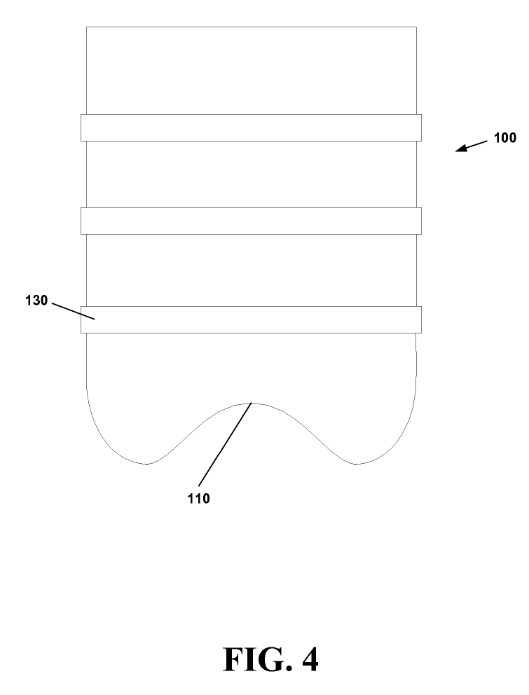

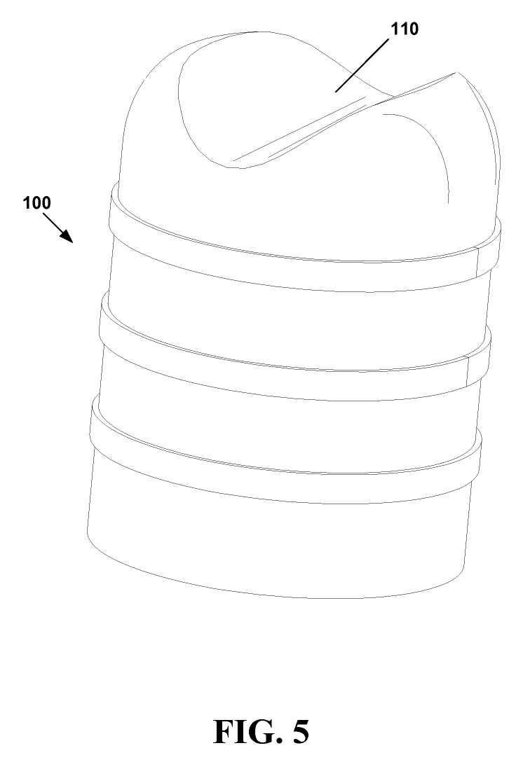

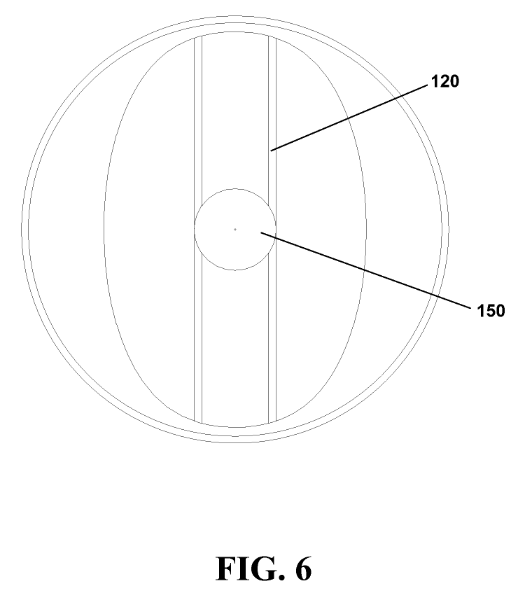

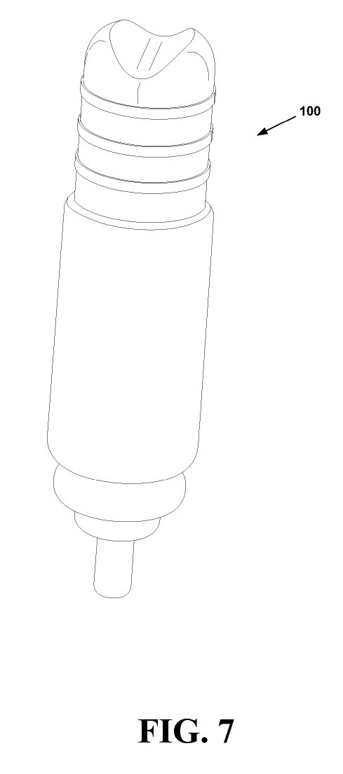

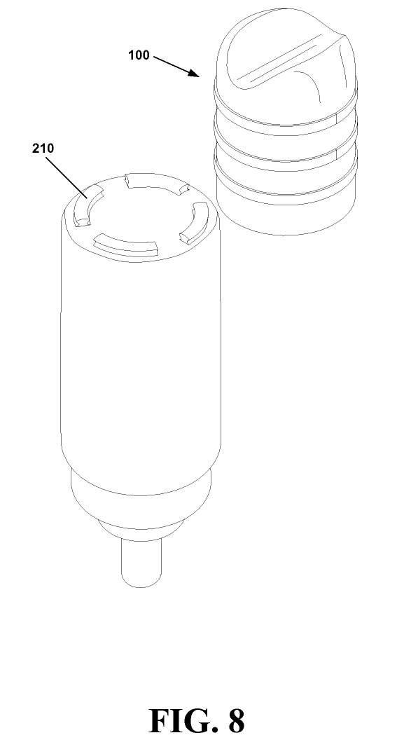

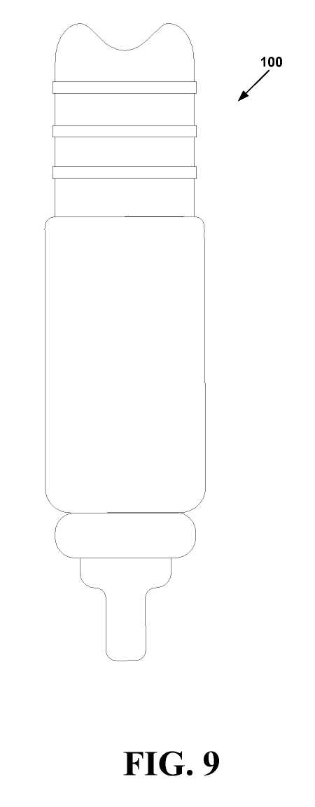

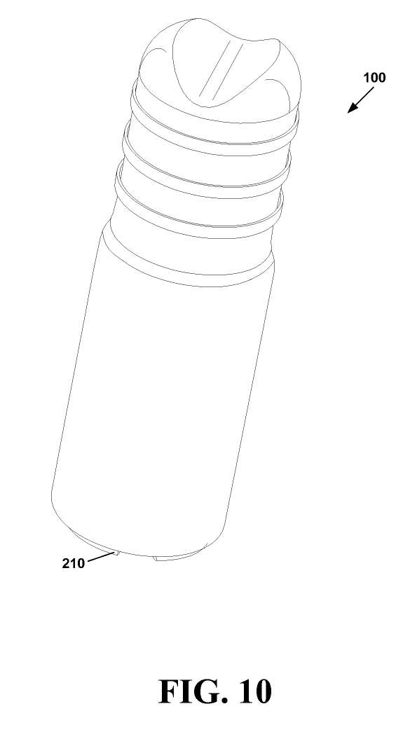

Referring now to FIG. 1 through FIG. 10, a baby bottle cap 100 is comprised of a cap base 140 that is formed to have a chin recess 110 on the top of the cap base. The chin recess has a plurality of chin grippers 120 disposed on the top outside of the chin recess 110.

The baby bottle cap 100 is further comprised of a plurality of side grippers 130 disposed on the outside surface of the cap base 140. The baby bottle cap 100 is further comprised of nipple stopper 150 disposed on the top inside of cap base 140, where nipple stopper 150 is positioned to fit snugly against nipple 220 such that liquid cannot emanate from the nipple orifice.

The baby bottle cap 100 is formed to fit on either the top or bottom of a correspondingly formed baby bottle 200. The baby bottle 200 may have bottle cap retainers 210 formed on the bottom of baby bottle 200. The bottle cap retainers 210 are formed such that the baby bottle cap 100 snaps to, or snugly fits on, the bottle cap retainers 210.

The present invention relates to a baby feeding system comprising a baby bottle having a top, a bottle and an opening in the top, a nipple removably attached to the opening, where the nipple has an feeding orifice, means for extending the length of the baby bottle, means for chin-holding of the baby bottle, means for closing the feeding orifice.

The means for extending is comprised of a baby bottle cap having a top side having a top surface and a bottom surface, a cylindrical side extending from the top surface to a bottom end of the baby bottle cap wherein the cylindrical side forms an opening that extends from the top side to the bottom end and is formed to attach to the bottom of the baby bottle.

The means for chin-holding is comprised of a chin-fitting indention formed in the top side of the baby bottle cap. At least one gripping protrusion is disposed on the chin-fitting indention. At least one gripping protrusion is disposed on the cylindrical side.

The means for closing the feeding orifice is preferably a protrusion affixed to the bottom end of the baby bottle cap, wherein the protrusion is centrally positioned to match the location of the orifice of the baby bottle nipple.

Another way to describe the present invention is as follows. A baby bottle cap for removable attachment to either the top or bottom of a baby bottle comprised of a top having an indention with a top side and a bottom side with at least one chin gripper disposed on the top side and a nipple stopper disposed on the bottom side, a cylindrical side protruding downward from the top side; and at least one gripper disposed on the cylindrical side. The nipple stopper may be a spongy spheroid. The nipple stopper may have a projection formed to fit into an orifice of a baby bottle nipple.

From the foregoing, it will be appreciated that, although specific embodiments of the invention have been described herein for purposes of illustration, various modifications may be made without deviating from the spirit and scope of the invention. For example, many of the features and components described above in the context of a particular baby bottle cap configuration can be incorporated into other configurations in accordance with other embodiments of the invention. Accordingly, the invention is not limited except by the appended claims.

What is claimed is:

1. A baby feeding system comprising:
a baby bottle having a top, a bottom and an opening in the top wherein the bottle has a length;
a nipple removably attached to the opening, wherein the nipple has a feeding orifice;
means for extending the length of the baby bottle;
means for chin-holding of the baby bottle; and
means for closing the feeding orifice.

2. The baby feeding system as recited in claim 1, wherein the means for extending is comprised of a baby bottle cap having a top side having a top surface and a bottom surface, a cylindrical side extending from the top surface to a bottom end of the baby bottle cap wherein the cylindrical side forms an opening that extends from the top side to the bottom end and is formed to attach to the bottom of the baby bottle.

3. The baby feeding system as recited in claim 2, wherein the means for chin-holding is comprised of a chin-fitting indention formed in the top side of the baby bottle cap.

4. The baby feeding system as recited in claim 3, wherein at least one gripping protrusion is disposed on the chin-fitting indention.

5. The baby feeding system as recited in claim 4, wherein at least one gripping protrusion is disposed on the cylindrical side.

6. The baby feeding system as recited in claim 5, wherein the means for closing the feeding orifice is a protrusion affixed to the bottom end of the baby bottle cap, wherein the protrusion is centrally positioned.

7. The baby feeding system as recited in claim 5, wherein the means for closing the feeding orifice is a protrusion formed at the bottom end of the baby bottle cap, wherein the protrusion is centrally positioned.

8. A baby bottle cap for removable attachment to either the top or bottom of a baby bottle comprised of
a top having an indention with a top side and a bottom side with at least one chin gripper disposed on the top side and a nipple stopper disposed on the bottom side;
a cylindrical side protruding downward from the top side; and
at least one gripper disposed on the cylindrical side.

9. The baby bottle cap as recited in claim 8, wherein the nipple stopper is a spongy spheroid.

10. The baby bottle cap as recited in claim 8, wherein the nipple stopper has a projection formed to fit into an orifice of a baby bottle nipple.

11. A baby bottle cap characterized by means for selectively attaching to a top or a bottom of a baby bottle.
